(19) United States
(12) Patent Application Publication
(10) Pub. No.: US 2019/0246085 A1
(43) Pub. Date: Aug. 8, 2019

(54) PROJECTOR AND CONTROL METHOD OF PROJECTOR

(71) Applicant: SEIKO EPSON CORPORATION, Tokyo (JP)

(72) Inventor: Takumi OIKE, Matsumoto-shi (JP)

(73) Assignee: SEIKO EPSON CORPORATION, Tokyo (JP)

(21) Appl. No.: 16/264,808

(22) Filed: Feb. 1, 2019

(30) Foreign Application Priority Data
Feb. 2, 2018 (JP) 2018-017683

(51) Int. Cl. H04N 9/31

(52) U.S. Cl. CPC H04N 9/3194; G03B 21/006; H04N 9/3179

(57) ABSTRACT

A projector includes a measurement unit that measures a feature quantity of a first image projected on a projection surface from a position at a first angle relative to the projection surface and generates a first measurement result, a receiving unit that receives a second measurement result obtained by measurement of the feature quantity of the first image in a position at a second angle different from the first angle relative to the projection surface, a determination unit that determines reflection characteristics of the projection surface based on the first measurement result and the second measurement result, a correction unit that corrects first image information and generates second image information based on the reflection characteristics of the projection surface determined by the determination unit, and a projection unit that projects a second image according to the second image information generated by the correction unit on the projection surface.

The entire disclosure of Japanese Patent Application No. 2018-θ17683, filed Feb. 2, 2018 is expressly incorporated by reference herein.

### BACKGROUND

### 1. Technical Field

The present invention relates to a projector and a control method of the projector.

### 2. Related Art

Regarding images projected by a projector on a projection surface such as a screen, a user may recognize unevenness of display (e.g. unevenness of brightness or color).

The unevenness of display occurs, for example, when the projection surface has reflection characteristics of changing reflectance of light according to the reflection angle of the light.

For example, when a user observes an image projected on the projection surface, the reflection angles by the projection surface are different in an image portion reflected at the center of the projection surface and observed by the user and an image portion reflected at the end of the projection surface and observed by the user. Accordingly, when the projection surface has the reflection characteristics of changing reflectance of light according to the reflection angle of the light, the user recognizes the image with unevenness of display.

Patent Document 1 (JP-A-2011-205199) discloses an image display system that can suppress unevenness of display due to reflection characteristics of a projection surface. In order to reduce unevenness of display or the like, the image display system corrects image information based on the reflection characteristics of the projection surface and projects and displays an image according to the corrected image information on the projection surface.

The image display system corrects the image information using characteristic information on the reflection characteristics of the projection surface input by the user.

In the image display system disclosed in Patent Document 1, it is necessary for the user to input the characteristic information on the reflection characteristics of the projection surface and the system is not user-friendly.

### SUMMARY

An advantage of some aspects of the invention is to provide a technique that enables correction of image information based on reflection characteristics of a projection surface without input of characteristic information on the reflection characteristics of the projection surface by a user.

An aspect of a projector according to the invention includes a measurement unit that measures a feature quantity of a first image projected on a projection surface from a position at a first angle relative to the projection surface and generates a first measurement result, a receiving unit that receives a second measurement result obtained by measurement of the feature quantity of the first image in a position at a second angle different from the first angle relative to the projection surface, a determination unit that determines reflection characteristics of the projection surface based on the first measurement result and the second measurement result, a correction unit that corrects first image information and generates second image information based on the reflection characteristics of the projection surface determined by the determination unit, and a projection unit that projects a second image according to the second image information generated by the correction unit on the projection surface.

According to the aspect, the reflection characteristics of the projection surface are determined based on the first measurement result and the second measurement result, and the first image information is corrected based on the reflection characteristics of the projection surface. Accordingly, the image information can be corrected based on the reflection characteristics of the projection surface without input of characteristic information on the reflection characteristics of the projection surface by a user.

Note that the phrase “based on the first measurement result and the second measurement result” includes “based on at least the first measurement result and the second measurement result”.

In the aspect of the projector, it is desirable that the first measurement result shows a measurement result of measurement of a feature quantity of a measuring object portion contained in the first image from the position at the first angle, the second measurement result shows a measurement result of measurement of a feature quantity of the measuring object portion contained in the first image from the position at the second angle, and a position of the measuring object portion measured from the position at the first angle in the first image is the same as a position of the measuring object portion measured from the position at the second angle in the first image.

According to the configuration, for example, even when there is unevenness of color in the first image itself projected on the projection surface, the same location of the first image is measured, and thereby, the influence of the unevenness of color in the first image itself on the difference between the first measurement result and the second measurement result can be suppressed.

In the aspect of the projector, it is desirable that the determination unit determines the reflection characteristics of the projection surface from a plurality of candidates of reflection characteristics based on the first measurement result and the second measurement result.

According to the configuration, the candidate similar to the real reflection characteristics of the projection surface can be determined as the reflection characteristics of the projection surface from the plurality of candidates of reflection characteristics.

In the aspect of the projector, it is desirable that the determination unit obtains a feature quantity of the first image corresponding to a position at an angle between the first angle and the second angle by executing interpolation calculation based on the first measurement result and the second measurement result, and determines the reflection characteristics of the projection surface using the first measurement result, the second measurement result, and the feature quantity of the first image corresponding to the position at the angle between the first angle and the second angle.

According to the configuration, for example, the reflection characteristics of the projection surface may be determined without a candidate of reflection characteristics.

In the aspect of the projector, it is desirable that a memory unit that stores the reflection characteristics of the projection surface determined by the determination unit, an operation unit that receives an operation by a user, and a reading unit that reads the reflection characteristics of the projection surface from the memory unit when the operation unit receives an operation of reading the reflection characteristics of the projection surface are provided.

According to the configuration, the reflection characteristics of the projection surface can be read according to the operation by the user.

In the aspect of the projector, it is desirable that the measurement unit is an imaging unit that captures the first image projected on the projection surface from the position at the first angle and generates an imaging result as the first measurement result.

According to the configuration, the reflection characteristics of the projection surface can be determined using the imaging result of the first image.

In the aspect of the projector, it is desirable that the projection unit projects an image containing an angle detection pattern as the first image, and a specification unit that specifies the first angle based on an imaging result of the angle detection pattern by the imaging unit is further provided.

According to the configuration, the imaging result of the first image used for determination of the reflection characteristics of the projection surface may be also used as information for specification of the imaging angle.

In the aspect of the projector, it is desirable that the specification unit specifies the first angle based on a degree of deformation of the angle detection pattern shown in the imaging result.

The angle detection pattern shown in the imaging result deforms according to the imaging angle. Therefore, according to the configuration, the first angle can be specified.

In the aspect of the projector, it is desirable that the projection unit projects an image containing the angle detection pattern and a guide image prompting measurement of the angle detection pattern at the second angle as the first image, and the receiving unit receives the second measurement result after projection of the image containing the angle detection pattern and the guide image.

According to the configuration, for example, the second measurement result at the predetermined second angle can be used.

Another aspect of a projector according to the invention includes a receiving unit that receives a first measurement result obtained by measurement of a feature quantity of a first image projected on a projection surface from a position at a first angle relative to the projection surface and a second measurement result obtained by measurement of the feature quantity of the first image in a position at a second angle different from the first angle relative to the projection surface, a determination unit that determines reflection characteristics of the projection surface based on the first measurement result and the second measurement result, a correction unit that corrects first image information and generates second image information based on the reflection characteristics of the projection surface determined by the determination unit, and a projection unit that projects a second image according to the second image information generated by the correction unit on the projection surface.

According to the configuration, the reflection characteristics of the projection surface are determined based on the first measurement result and the second measurement result, and the first image information is corrected based on the reflection characteristics of the projection surface. Accordingly, the image information can be corrected based on the reflection characteristics of the projection surface without input of characteristic information on the reflection characteristics of the projection surface by the user.

An aspect of a method according to the invention includes measuring a feature quantity of a first image projected on a projection surface from a position at a first angle relative to the projection surface and generating a first measurement result, receiving a second measurement result obtained by measurement of the feature quantity of the first image in a position at a second angle different from the first angle relative to the projection surface, determining reflection characteristics of the projection surface based on the first measurement result and the second measurement result, correcting first image information and generating second image information based on the reflection characteristics of the projection surface, and projecting a second image according to the second image information on the projection surface.

According to the configuration, the reflection characteristics of the projection surface are determined based on the first measurement result and the second measurement result, and the first image information is corrected based on the reflection characteristics of the projection surface. Accordingly, the image information can be corrected based on the reflection characteristics of the projection surface without input of characteristic information on the reflection characteristics of the projection surface by the user.

### BRIEF DESCRIPTION OF THE DRAWINGS

The invention will be described with reference to the accompanying drawings, wherein like numbers reference like elements.

FIG. 1 shows an image projection system including a projector according to a first embodiment.

FIG. 2 shows relationships between images of a white area shown in captured images and imaging angles.

FIG. 3 shows an example of imaging angles (reflection angles).

FIG. 4 shows an example of the projector.

FIG. 5 shows an example of candidate A.

FIG. 6 shows an example of candidate B.

FIG. 7 shows an example of candidate C.

FIG. 8 is a flowchart for explanation of operation of the projector.

FIG. 9 shows examples of reflection angle characteristics of brightness.

FIG. 10 shows an example of plotting reflection angle characteristics of brightness in candidate B.

FIG. 11 is a flowchart for explanation of a correction operation.

FIG. 12 shows a relationship between a reflection angle and chromaticity (error in chromaticity) of candidate A.

FIG. 13 shows a relationship between the reflection angle and chromaticity (error in chromaticity) of candidate B.

FIG. 14 shows a relationship between the reflection angle and chromaticity (error in chromaticity) of candidate C.

FIG. 15 shows a relationship between the reflection angle and chromaticity (error in chromaticity) of candidate A.

FIG. 16 shows a relationship between the reflection angle and chromaticity (error in chromaticity) of candidate B.

FIG. 17 shows a relationship between the reflection angle and chromaticity (error in chromaticity) of candidate C.

FIG. 18 is a flowchart for explanation of operation of modified example 1.

FIG. 19 shows an example of the reflection angle characteristics of chromaticity.

FIG. 20 shows an example of the reflection angle characteristics of chromaticity.

FIG. 21 shows modified examples 2 and 3.

FIG. 22 shows an example of imaging angles (reflection angles).

FIG. 23 shows an example of an image containing a white angle detection pattern, a guide image, and a black background area.

FIG. 24 shows an example of the angle detection pattern.

### DESCRIPTION OF EXEMPLARY EMBODIMENTS

As below, embodiments according to the invention will be explained with reference to the drawings. Note that, in the drawings, the dimensions and scaling of the respective parts are different from real ones as appropriate. Further, the embodiments to be described are preferred specific examples of the invention. Accordingly, technically preferable various limitations are made to the embodiments. However, the scope of the invention is not limited to these embodiments unless there is description that particularly limits the invention in the following explanation.

### First Embodiment

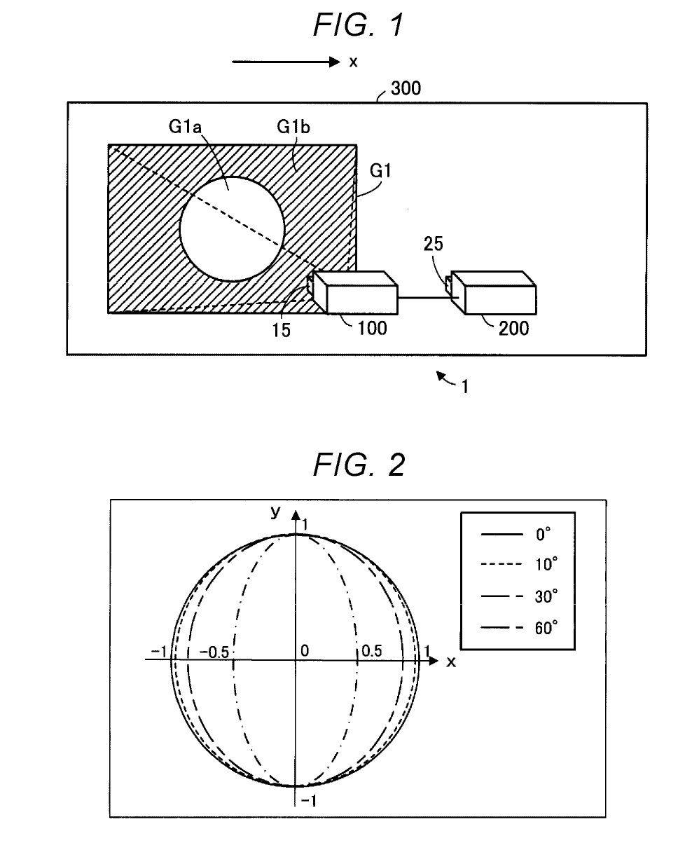

FIG. 1 shows an image projection system 1 including a projector 100 according to the first embodiment. The image projection system 1 includes the projector 100 and a projector 200. The projector 100 and the projector 200 are placed side by side in the x-axis direction shown in FIG. 1. The number of projectors forming the image projection system 1 is not limited to two, but may be three or more. The projector 100 and the projector 200 are connected by wired or wireless connection. The projector 100 functions as a master and the projector 200 functions as a slave.

The image projection system 1 projects and displays an image on a screen 300. The image projected by the image projection system 1 is formed by e.g. an image projected by the projector 100 and an image (not shown) projected by the projector 200. The screen 300 is an example of a projection surface.

The image projection system 1, i.e., the projector 100 has a function of specifying the reflection characteristics of the screen 300 (hereinafter, also referred to as “specification function”).

The reflection characteristics of the screen 300 are expressed by e.g. a relationship between the reflection angle of light in the screen 300 and the reflectance of the light reflected at the reflection angle. The reflectance of the light is reflected in the brightness of the reflected light (hereinafter, also referred to as “reflected light brightness”) and the color of the reflected light (hereinafter, also referred to as “reflected light color”). Accordingly, the reflection characteristics of the screen 300 are also expressed by the relationship between the reflection angle and the reflected light brightness and the relationship between the reflection angle and the reflected light color.

The projector 100 projects and displays an image G1 used for specification of the reflection characteristics of the screen 300 on the screen 300. The image G1 is an example of a first image. The image G1 includes a circular white area G1a and a black area G1b. The white area G1a is an example of a measuring object portion and angle detection pattern.

When the white area G1a is imaged, the white area G1a shown in the captured image deforms according to the imaging angle. For example, assuming that the imaging angle is an angle relative to the normal of the screen 300, as the imaging position is farther in the x-axis direction from the position in front of the white area G1a, the width of the white area G1a in the x-axis direction shown in the captured image is narrower.

FIG. 2 shows relationships between images of the white area G1a shown in the captured images and imaging angles. As shown in FIG. 2, as the imaging angle is larger, the width of the white area G1a in the x-axis direction shown in the captured image is narrower. That is, the shape of the white area G1a in the captured image corresponds to the imaging angle.

For example, regarding an ellipse observed when a perfect circle having a radius a expressed by a relationship x²+y²=a is measured from a position at an angle θ, letting the x-coordinate in the ellipse be S and the y-coordinate be T, S and T are obtained by the following expressions (1) and (2). Here, θ is 0° in the normal direction of the screen 300, +(positive) is on the right side facing the screen 300, and −90°≤θ≤90°.

S=x·sin θ (1)

T=y (2)

where the imaging angle is equal to the reflection angle.

In the projector 100, an imaging unit 15 generates captured image information (hereinafter, also referred to as “first captured image information”) by imaging of the image G1 displayed on the screen 300 at an imaging angle θ1. In other words, the imaging unit 15 generates the first captured image information by imaging the image G1 reflected by the screen 300 at the reflection angle θ1.

The first captured image information represents the brightness and the color of the image G1 when the image G1 displayed on the screen 300 is captured at the imaging angle θ1. That is, the first captured image information represents the actual measurement values of the reflection characteristics of the screen 300 at the imaging angle θ1. The brightness and the color of the image G1 are respectively examples of feature quantities of the image G1. The first captured image information is an example of an imaging result and a first measurement result. Further, as described above, the shape of the white area G1a represented by the first captured image information corresponds to the imaging angle θ1, i.e., the reflection angle θ1. Accordingly, the first captured image information represents the imaging angle (reflection angle) θ1 and the reflection characteristics of the screen 300 at the imaging angle (reflection angle) θ1.

In the projector 200, an imaging unit 25 generates captured image information (hereinafter, also referred to as “second captured image information”) by imaging of the image G1 displayed on the screen 300 at an imaging angle θ2.

The second captured image information represents the brightness and the color of the image G1 when the image G1 displayed on the screen 300 is captured at the imaging angle θ2. That is, the second captured image information represents the actual measurement values of the reflection characteristics of the screen 300 at the imaging angle θ2. The second captured image information is an example of a second measurement result. The shape of the white area G1a represented by the second captured image information corresponds to the imaging angle (reflection angle) θ2. Accordingly, the second captured image information represents the imaging angle (reflection angle) θ2 and the reflection characteristics of the screen 300 at the imaging angle (reflection angle) θ2.

The projector 200 provides the second captured image information to the projector 100.

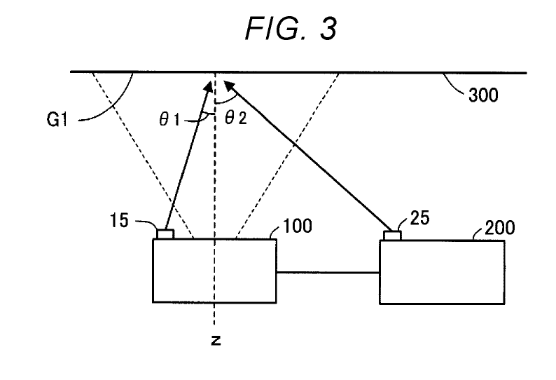

FIG. 3 shows examples of the imaging angles (reflection angles) θ1 and θ2. As described above, the imaging angles θ1 and θ2 are angles relative to the normal z of the screen 300. The imaging angle θ1 is an example of a first angle. The imaging angle θ2 is an example of a second angle.

The projector 100 determines the reflection characteristics of the screen 300 based on the first captured image information and the second captured image information.

For example, the projector 100 specifies the imaging angle (reflection angle) θ1 based on the shape of the white area G1a represented by the first captured image information. Further, the projector 100 specifies the brightness of the white area G1a represented by the first captured image information as the brightness of the white area G1a at the imaging angle (reflection angle) θ1.

The projector 100 specifies the imaging angle (reflection angle) θ2 based on the shape of the white area G1a represented by the second captured image information. Further, the projector 100 specifies the brightness of the white area G1a represented by the second captured image information as the brightness of the white area G1a at the imaging angle (reflection angle) θ2.

The projector 100 determines the reflection characteristics of the screen 300 based on the brightness of the white area G1a at the imaging angle (reflection angle) θ1 and the brightness of the white area G1a at the imaging angle (reflection angle) θ2.

Next, an example of the projector 100 will be explained.

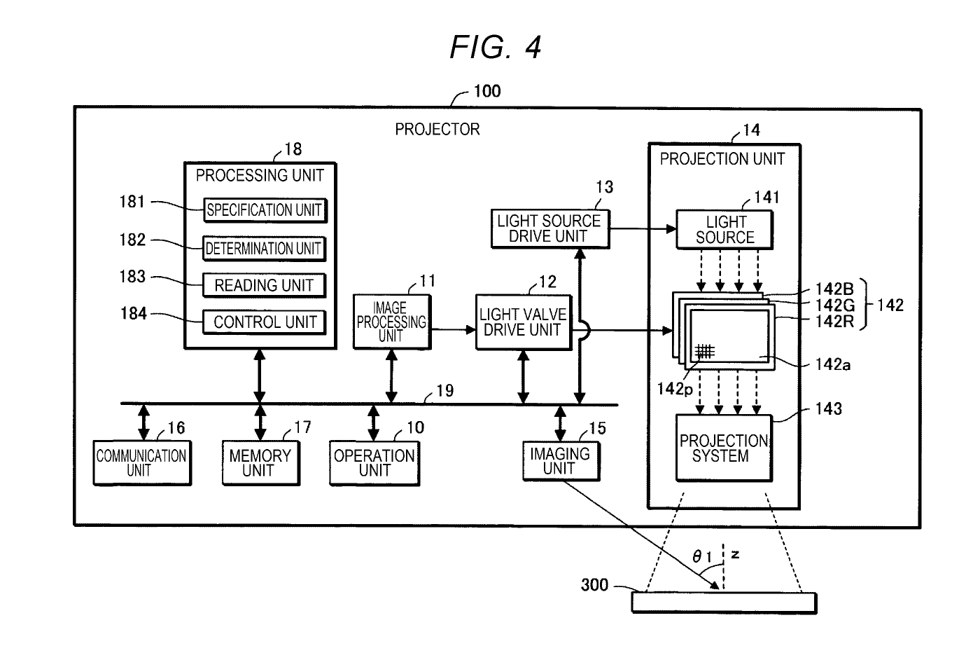

FIG. 4 shows an example of the projector 100. The projector 100 includes an operation unit 10, an image processing unit 11, a light valve drive unit 12, a light source drive unit 13, a projection unit 14, the imaging unit 15, a communication unit 16, a memory unit 17, a processing unit 18, and a bus 19. The projection unit 14 includes a light source 141, three liquid crystal light valves 142 (142R, 142G, 142B), and the projection system 143.

The operation unit 10, the image processing unit 11, the light valve drive unit 12, the light source drive unit 13, the imaging unit 15, the communication unit 16, the memory unit 17, and the processing unit 18 are mutually communicable via the bus 19.

The operation unit 10 is e.g. various operation buttons, operation keys, or touch panels. The operation unit receives operations by a user of the projector 100 (hereinafter, simply referred to as “user”). The operation unit 10 may be a remote controller that transmits information according to the operation by the user via wireless or wired connection. In this case, the projector 100 includes a receiving unit that receives information transmitted by the remote controller. The remote controller includes various operation buttons, operation keys, or touch panels that receive operations by the user.

The image processing unit 11 performs image processing on image information and generates an image signal. For example, the image processing unit 11 performs image processing on image information based on the reflection characteristics of the screen 300 and generates an image signal. The image processing unit 11 is an example of a correction unit. The image information subjected to image processing by the image processing unit 11 is an example of first image information. The image signal is an example of second image information. The image processing unit 11 is a computer such as a CPU (Central Processing Unit). The image processing unit 11 may be formed by one or more processors. The image processing unit 11 realizes the function of the image processing unit 11 by reading and executing a program stored in the memory unit 17.

The light valve drive unit 12 drives the liquid crystal light valves 142 (142R, 142G, 142B) based on the image signal generated by the image processing unit 11.

The light source drive unit 13 drives the light source 141. For example, the light source drive unit 13 allows the light source 141 to emit light when the operation unit 10 receives a power-on operation.

The projection unit 14 projects an image according to the image information (image signal) on the screen 300. In the projection unit 14, the light emitted from the light source 141 is modulated by the liquid crystal light valves 142 and image light is generated, and the image light is enlarged and projected from the projection system 143 on the screen 300.

The light source 141 is a xenon lamp, ultrahigh-pressure mercury lamp, LED (Light Emitting Diode), laser light source, or the like. The light source 141 emits light. The variations in brightness distribution of the light emitted from the light source 141 are reduced by an optical integration system (not shown), and then, the light is separated into color light components of red (R), green (G), blue (B) as three primary colors of light by a color separation system (not shown). The color light components of R, G, B enter the liquid crystal light valves 142R, 142G, 142B, respectively.

The liquid crystal light valve 142 modulates the light emitted by the light source 141 and generates image light (image) according to the image signal (image information). The liquid crystal light valve 142 is formed by a liquid crystal panel with liquid crystal enclosed between a pair of transparent substrates or the like. In the liquid crystal light valve 142, a rectangular pixel area 142a including a plurality of pixels 142p arranged in a matrix form is formed. In the liquid crystal light valve 142, a drive voltage is applied to the liquid crystal with respect to each pixel 142p.

When the light valve drive unit 12 applies the drive voltages according to the image signal to the respective pixels 142p, the respective pixels 142p are set to light transmissivity according to the image signal. Accordingly, the light emitted by the light source 141 is transmitted through the pixel area 142a and modulated and images according to the image signal are formed for the respective color lights. The images of the respective colors are combined by a light combining system (not shown) with respect to each pixel 142p and color image light is obtained.

The projection system 143 enlarges and projects the image light generated by the liquid crystal light valves 142 on the screen 300.

The imaging unit 15 images the screen 300. For example, the imaging unit 15 captures the image G1 projected on the screen 300 and generates the first captured image information. The imaging unit 15 is an example of a measurement unit. Further, the imaging unit 15 images a pointer (e.g. a finger of the user or electronic pen) on the screen 300 and generates captured image information according to the captured image showing the pointer. The captured image information according to the captured image showing the pointer is used for detection of the position of the pointer on the screen 300 by the projector 100 (e.g. a control unit 184, which will be described later).

The communication unit 16 communicates with other apparatuses including the projector 200. For example, the communication unit 16 receives the second captured image information from the projector 200. The communication unit 16 is an example of a receiving unit that receives the second captured image information.

The memory unit 17 is a computer-readable recording medium. The memory unit 17 stores programs that specify the operation of the projector 100 and various kinds of information. For example, the memory unit 17 stores image information representing the image G1 (hereinafter, also referred to as “measurement image information”) and other image information. Further, the memory unit 17 stores the reflection characteristics of the screen 300 determined by a determination unit 182, which will be described later.

The processing unit 18 is a computer such as a CPU (Central Processing Unit). The processing unit 18 may be formed by one or more processors. The processing unit 18 realizes a specification unit 181, the determination unit 182, a reading unit 183, and the control unit 184 by reading and executing programs stored in the memory unit 17.

The specification unit 181 specifies the imaging angle (reflection angle) θ1 based on the white area G1a represented by the first captured image information. For example, the specification unit 181 specifies the imaging angle θ1 based on the degree of deformation of the white area G1a represented by the first captured image information. In the embodiment, the specification unit 181 specifies the imaging angle θ1 using the x-coordinate of the white area G1a represented by the first captured image information and the above described expression (1). In other words, the specification unit 181 specifies the imaging angle θ1 by obtaining, of circles specified using the above described expression (1) and expression (2), an angle θ at which the circle is closest to the shape of the white area G1a represented by the first captured image information.

Further, the specification unit 181 specifies the imaging angle (reflection angle) θ2 based on the white area G1a represented by the second captured image information. For example, the specification unit 181 specifies the imaging angle θ2 based on the degree of deformation of the white area G1a represented by the second captured image information. In the embodiment, the specification unit 181 specifies the imaging angle θ2 using the x-coordinate of the white area G1a represented by the second captured image information and the above described expression (1). In other words, the specification unit 181 specifies the imaging angle θ2 by obtaining, of circles specified using the above described expression (1) and expression (2), an angle θ at which the circle is closest to the shape of the white area G1a represented by the second captured image information.

The determination unit 182 determines the reflection characteristics of the screen 300 based on the first captured image information and the second captured image information.

For example, the determination unit 182 specifies the brightness of the white area G1a represented by the first captured image information as the brightness of the white area G1a at the imaging angle (reflection angle) θ1 determined by the specification unit 181. Further, the determination unit 182 specifies the brightness of the white area G1a represented by the second captured image information as the brightness of the white area G1a at the imaging angle (reflection angle) θ2 determined by the specification unit 181.

The determination unit 182 determines the reflection characteristics of the screen 300 based on the brightness of the white area G1a at the imaging angle (reflection angle) θ1 and the brightness of the white area G1a at the imaging angle (reflection angle) θ2.

As an example, the determination unit 182 creates reflection angle characteristics of brightness indicating the relationship between the brightness and the imaging angle (reflection angle) on the screen 300 using the brightness of the white area G1a at the imaging angle θ1 and the brightness of the white area G1a at the imaging angle θ2. Subsequently, the determination unit 182 determines, of a plurality of candidates relating to the reflection characteristics of the screen 300, the candidate closest to the reflection angle characteristics of brightness of the screen 300 as the reflection characteristics of the screen 300. The determination unit 182 stores the reflection characteristics of the screen 300 in the memory unit 17.

When the operation unit 10 receives an operation of reading the reflection characteristics of the screen 300, the reading unit 183 reads the reflection characteristics of the screen 300 from the memory unit 17. The reflection characteristics of the screen 300 read by the reading unit 183 are transmitted to e.g. the projector 200.

The control unit 184 controls the operation of the projector 100. For example, the control unit 184 controls the image processing unit 11 to control projection of the image.

The projector 200 shown in FIG. 1 includes the same configurations as the configurations of the projector 100. Note that the imaging unit 25 of the projector 200 shown in FIG. 1 has the same configuration as the imaging unit 15 of the projector 100.

Further, when receiving an imaging command from the projector 100, the projector 200 captures the image G1 using the imaging unit 25 and generates the second captured image information, and transmits the second captured image information to the projector 100. The projector 200 does not necessarily project the image G1.

Next, the operation will be explained.

In the following description, it is assumed that the memory unit 17 stores a plurality of candidates relating to the reflection characteristics of the screen 300. In the embodiment, the memory unit 17 stores three candidates of candidates A, B, and C. The candidate A may be referred to as “diffuse reflection type”. The candidate B may be referred to as “retroreflection type”. The candidate C may be referred to as “specular reflection type”.

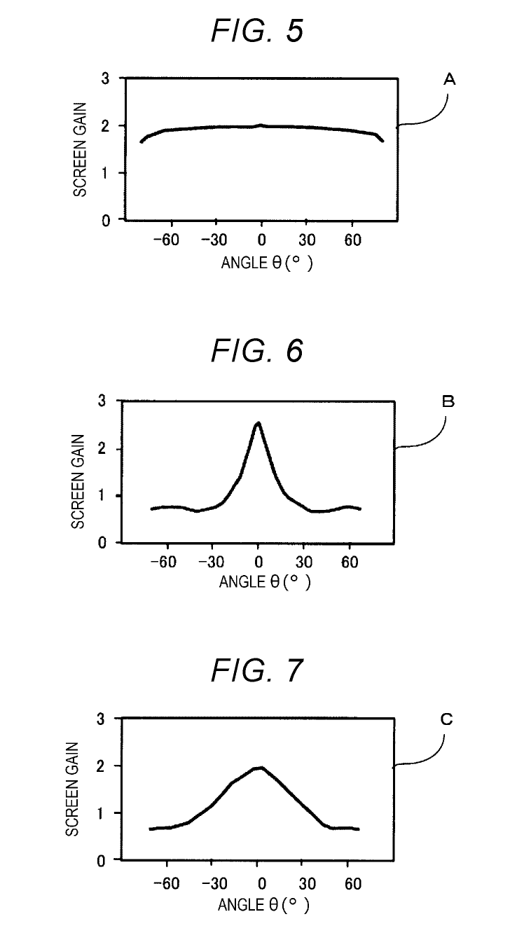

FIG. 5 shows an example of candidate A. FIG. 6 shows an example of candidate B. FIG. 7 shows an example of candidate C. The candidates A, B, and C show relationships between the reflection angle and screen gain. The screen gain refers to a rate of a brightness value obtained by irradiation of a screen material with light at each angle under the same condition to the brightness value of reflected light radiated from a certain light source to a perfect diffuser as “1”.

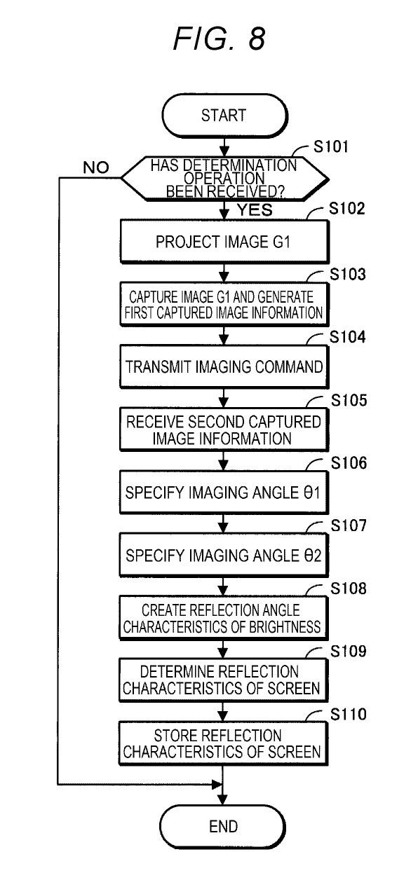

FIG. 8 is a flowchart for explanation of an operation of the image projection system 1, i.e., the operation of the projector 100.

If the operation unit 10 receives an operation of determining the characteristics of the screen 300 (step S101) from the user, the control unit 184 reads the measurement image information from the memory unit 17. Subsequently, the control unit 184 outputs the measurement image information to the image processing unit 11. The image processing unit 11 performs image processing on the measurement image information and generates a measurement image signal. The light valve drive unit 12 drives the liquid crystal light valves 142 according to the measurement image signal, and the projection unit 14 projects and displays the image G1 (see FIG. 1) as a first image on the screen 300 (step S102).

Then, the control unit 184 allows the imaging unit 15 to execute the operation of capturing the image G1 on the screen 300. The imaging unit 15 captures the image G1 on the screen 300 and generates the first captured image information (step S103).

Subsequently, the control unit 184 transmits the imaging command to the projector 200 using the communication unit 16 (step S104). When the projector 200 receives the imaging command, the imaging unit 25 captures the image G1 on the screen 300 and generates the second captured image information. Then, the projector 200 transmits the second captured image information to the projector 100.

In the projector 100, the communication unit 16 receives the second captured image information from the projector 200 (step S105).

Subsequently, the specification unit 181 specifies the imaging angle (reflection angle) θ1 based on the degree of deformation of the white area G1a represented by the first captured image information (step S106) as described above.

Then, the specification unit 181 specifies the imaging angle (reflection angle) θ2 based on the degree of deformation of the white area G1a represented by the second captured image information (step S107) as described above.

Subsequently, the determination unit 182 creates the reflection angle characteristics of brightness of the screen 300 using the first captured image information and the second captured image information (step S108).

At step S108, the determination unit 182 operates in the following manner. Note that it is assumed that the first captured image information and the second captured image information represent pixel values using the XYZ color system.

First, the determination unit 182 obtains representative values (X1, Y1, Z1) of the white area G1a represented by the first captured image information. For example, the determination unit 182 calculates average values of the pixel values within the white area G1a represented by the first captured image information as the representative values (X1, Y1, Z1). Y1 functions as a representative value of the brightness of the white area G1a imaged at the imaging angle θ1.

Subsequently, the determination unit 182 obtains representative values (X2, Y2, Z2) of the white area G1a represented by the second captured image information. For example, the determination unit 182 calculates average values of the pixel values within the white area G1a represented by the second captured image information as the representative values (X2, Y2, Z2). Y2 functions as a representative value of the brightness of the white area G1a imaged at the imaging angle θ2.

Then, the determination unit 182 creates the reflection angle characteristics of brightness indicating the relationship between the brightness and the imaging angle (reflection angle) on the screen 300 using the set of the imaging angle θ1 and the brightness Y1 and the set of the imaging angle θ2 and the brightness Y2.

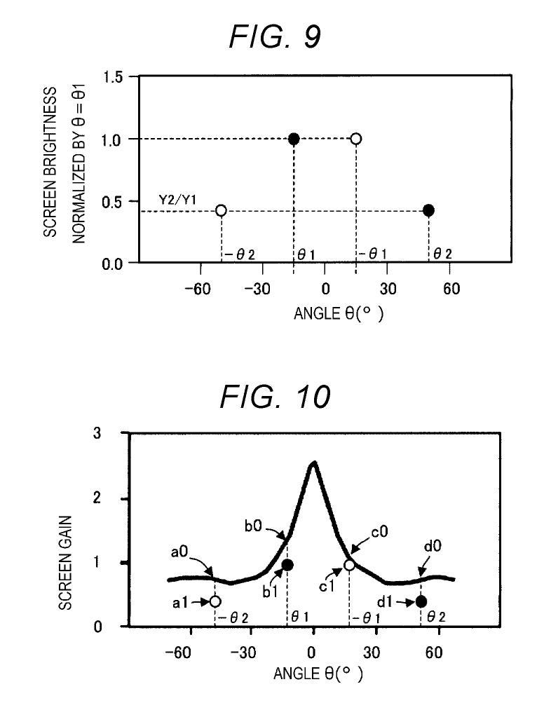

FIG. 9 shows examples of the reflection angle characteristics of brightness.

In FIG. 9, the horizontal axis indicates the imaging angle (reflection angle) and the vertical axis indicates the brightness, and the respective sets are plotted by black circles. Note that the brightness values are normalized by Y1. Generally, reflection characteristics of a screen are symmetric with respect to the normal of the screen, and accordingly, the determination unit 182 regards the brightness at the imaging angle −θ1 as Y1 and the brightness at the imaging angle −θ2 as Y2, and plots these sets in white.

Thus far, step S108 is explained.

Subsequently, the determination unit 182 determines the candidate closest to the reflection angle characteristics of brightness of the candidates A, B, and C as the reflection characteristics of the screen 300 (step S109).

At step S109, the determination unit 182 operates in the following manner.

First, the determination unit 182 plots the reflection angle characteristics of brightness (see FIG. 9) in the respective candidates A, B, and C (see FIGS. 5 to 7). FIG. 10 shows an example of plotting the reflection angle characteristics of brightness in candidate B.

Subsequently, the determination unit 182 calculates a value of the square of the difference between the screen gain value in the candidate A and the brightness shown by the reflection angle characteristics of brightness with respect to each of the imaging angles −θ2, θ1, −θ1, θ2, and calculates the positive value of the square roots of the sums of the squares as a coincidence related value α. The determination unit 182 also calculates the coincidence related values α with respect to each of the candidates B and C.

In the example shown in FIG. 10, the determination unit 182 calculates the positive value of the square roots of (a1−a0)²+(b1−b0)²+(c1−c0)²+(d1−d0)² as the coincidence related value α.

Then, the determination unit 182 determines the candidate having the smallest coincidence related value α of the candidates A, B, and C as the reflection characteristics of the screen 300.

Thus far, step S109 is explained.

Subsequently, the determination unit 182 stores the reflection characteristics of the screen 300 in the memory unit (step S110).

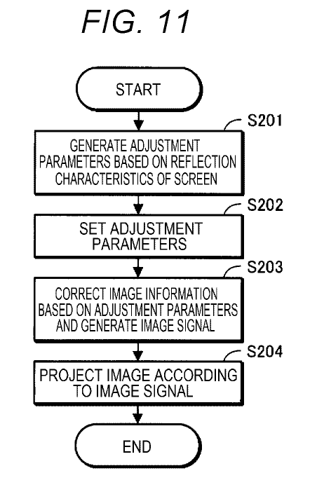

Next, the operation of correcting image information using the reflection characteristics of the screen 300 stored in the memory unit 17 (hereinafter, also referred to as “correction operation”) will be explained. FIG. 11 is a flowchart for explanation of the correction operation.

In the case where the screen gain of the screen 300 changes according to the reflection angle, even when an image with uniform brightness and color is projected on the screen 300, the user feels that the brightness is lower and the color is different in an image portion reflected in a relatively lower screen gain area than those in an image portion reflected in a relatively higher screen gain area.

Accordingly, the control unit 184 generates adjustment parameters for adjustment of the image processing so that the brightness of the image reflected in the relatively lower screen gain area may be higher and the color of the image may be closer to the color of the image reflected in the relatively higher screen gain area (step S201).

In the embodiment, the control unit 184 calculates the difference between the maximum value of the screen gain of the screen 300 and the screen gain at the reflection angle with respect to each reflection angle. Subsequently, the control unit 184 generates adjustment parameters for increasing the brightness and reducing unevenness of the color as the screen gain difference is larger.

Then, the control unit 184 sets the adjustment parameters in the image processing unit 11 (step S202).

The image processing unit 11 performs image processing on the image information according to the adjustment parameters and generates an image signal (step S203). Note that the image information subjected to the image processing according to the adjustment parameters may be input from an external apparatus or stored by the memory unit 17.

The light valve drive unit 12 drives the liquid crystal light valves 142 according to the image signal generated by the image processing unit 11, and the projection unit 14 projects and displays the image G1 (see FIG. 1) on the screen 300 (step S204).

According to the projector 100 and the control method of the projector 100 of the embodiment, the reflection characteristics of the screen 300 are determined based on the first captured image information and the second captured image information, and the image information is corrected based on the reflection characteristics of the screen 300 and the image signal is generated. Accordingly, the image information can be corrected based on the reflection characteristics of the screen 300 without input of characteristic information on the reflection characteristics of the screen 300 by the user.

Further, even when the reflection characteristics of the screen 300 change due to change with time of the screen 300, for example, the reflection characteristics of the screen 300 may be newly determined based on new first captured image information and new second captured image information. Therefore, the reflection characteristics of the screen 300 after change with time can be determined.

In the embodiment, the position of the white area G1a imaged from the position at the imaging angle θ1 in the image G1 is the same as the position of the white area G1a imaged from the position at the imaging angle θ2 in the image G1. Accordingly, for example, even when there is unevenness of color in the image G1 itself projected on the screen 300, the same location of the image G1 is captured, and thereby, the influence of the unevenness of color in the image G1 itself on the difference between the first captured image information and the second captured image information can be suppressed.

Note that, in the case where the unevenness of color in the image G1 itself is lower or the like, the position of the white area G1a imaged from the position at the imaging angle θ1 in the image G1 may be different from the position of the white area G1a imaged from the position at the imaging angle θ2 in the image G1.

The determination unit 182 determines the reflection characteristics of the screen 300 from the plurality of candidates A to C of reflection characteristics based on the first captured image information and the second captured image information. Accordingly, the candidate similar to the real reflection characteristics of the screen 300 may be determined as the reflection characteristics of the screen 300 from the plurality of candidates of reflection characteristics. Further, if reflection characteristics of a plurality of typical screens as the screen 300 are used as the plurality of candidates of reflection characteristics, when the typical screen is used as the screen 300, the reflection characteristics of the screen 300 can be detected with higher accuracy.

The first captured image information is generated by the imaging unit 15 that images the screen 300 for specification of the position of the pointer on the screen 300. Accordingly, compared to the case where the first captured image information is generated by a dedicated imaging unit for generating only the first captured image information, not by the imaging unit 15, the number of component elements can be made smaller.

Note that, in the case where the number of component elements is not restricted, the first captured image information may be generated by a dedicated imaging unit for generating only the first captured image information, not by the imaging unit 15.

The first captured image information is used not only for determination of the feature amount (e.g. reflection brightness) of the screen 300 but also for specification of the imaging angle. Accordingly, compared to a configuration in which information for determination of the feature amount (e.g. reflection brightness) of the screen 300 and information for specification of the imaging angle are separated, the number of pieces of information may be made smaller.

Note that the information for determination of the feature amount (e.g. reflection brightness) of the screen 300 and the information for specification of the imaging angle may be separated. In this case, a projected image projected for determination of the feature amount (e.g. reflection brightness) of the screen 300 and a projected image projected for specification of the imaging angle may be different from each other.

### MODIFIED EXAMPLES

The invention is not limited to the above described embodiment, but e.g. various modifications to be described later can be made. Further, one or more modifications arbitrarily selected from the following modifications may be appropriately combined.

### Modified Example 1

In the above described embodiment, the characteristics showing the relationship between the reflection angle and the screen gain are used with respect to the candidates A to C. However, characteristics showing a relationship between the reflection angle and chromaticity may be further used with respect to the candidates A to C.

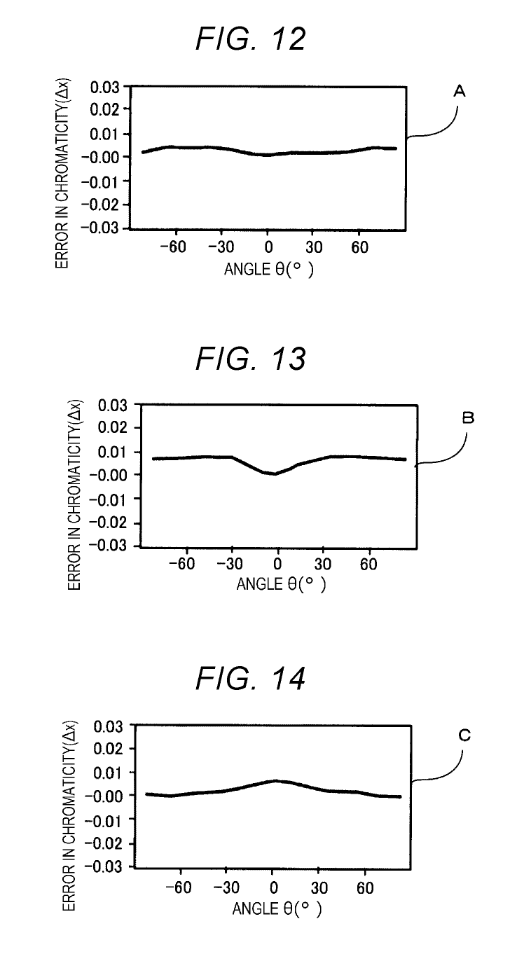

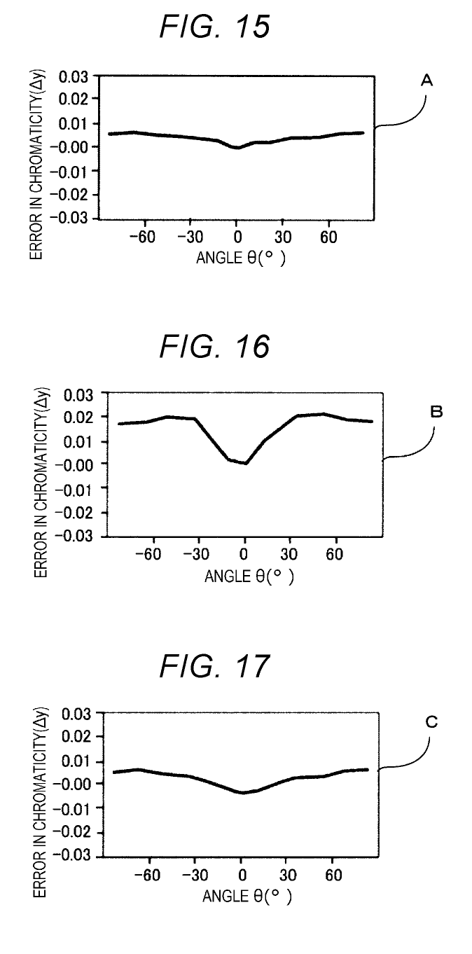

FIG. 12 shows a relationship between the reflection angle and chromaticity x (error in chromaticity x) of candidate A. FIG. 13 shows a relationship between the reflection angle and chromaticity x (error in chromaticity x) of candidate B. FIG. 14 shows a relationship between the reflection angle and chromaticity x (error in chromaticity x) of candidate C. FIG. 15 shows a relationship between the reflection angle and chromaticity y (error in chromaticity y) of candidate A. FIG. 16 shows a relationship between the reflection angle and chromaticity y (error in chromaticity y) of candidate B. FIG. 17 shows a relationship between the reflection angle and chromaticity y (error in chromaticity y) of the candidate C. The characteristics shown in FIGS. 12 to 17 are stored in the memory unit 17.

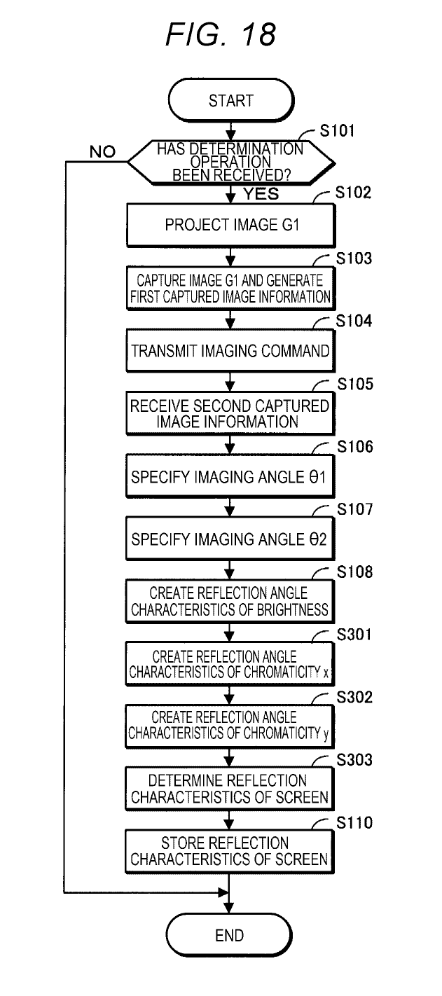

FIG. 18 is a flowchart for explanation of an operation of modified example 1. Of the processing shown in FIG. 18, the same processing as the processing shown in FIG. 8 has the same sign. As below, the operation of modified example 1 will be explained with a focus on the processing different from the processing shown in FIG. 8 of the processing shown in FIG. 18.

The determination unit 182 creates the reflection angle characteristics of brightness of the screen 300 (step S108), and creates reflection angle characteristics of chromaticity x of the screen 300 (step S301) using the first captured image information and the second captured image information.

At step S301, the determination unit 182 operates in the following manner.

First, the determination unit 182 calculates chromaticity x1 according to the following expression (3) using the representative values (X1, Y1, Z1) of the white area G1a represented by the first captured image information.

x=X/(X+Y+Z) (3)

Subsequently, the determination unit 182 calculates chromaticity x2 according to the expression (3) using the representative values (X2, Y2, Z2) of the white area G1a represented by the second captured image information.

Then, the determination unit 182 creates the reflection angle characteristics of chromaticity x indicating the relationship between the chromaticity x and the imaging angle (reflection angle) in the screen 300 using the set of the imaging angle θ1 and the chromaticity x1 and the set of the imaging angle θ2 and the chromaticity x2.

FIG. 19 shows an example of the reflection angle characteristics of the chromaticity x.

In FIG. 19, the horizontal axis indicates the imaging angle (reflection angle) and the vertical axis indicates the chromaticity x, and the respective sets are plotted by black circles. Note that the chromaticity values are obtained by subtraction of x1 in the respective sets. Generally, reflection characteristics of a screen are symmetric with respect to the normal of the screen, and accordingly, the determination unit 182 regards the chromaticity x at the imaging angle −θ1 as x1 and the chromaticity x at the imaging angle −θ2 as x2, and plots these sets (in white).

Thus far, step S301 is explained.

Subsequently, the determination unit 182 creates the reflection angle characteristics of chromaticity y of the screen 300 using the first captured image information and the second captured image information (step S302).

At step S302, the determination unit 182 operates in the following manner.

First, the determination unit 182 calculates chromaticity y1 according to the following expression (4) using the representative values (X1, Y1, Z1) of the white area G1a represented by the first captured image information.

y=Y/(X+Y+Z) (4)

Subsequently, the determination unit 182 calculates chromaticity x2 according to the expression (4) using the representative values (X2, Y2, Z2) of the white area G1a represented by the second captured image information.

Then, the determination unit 182 creates the reflection angle characteristics of chromaticity y indicating the relationship between the chromaticity y and the imaging angle (reflection angle) in the screen 300 using the set of the imaging angle θ1 and the chromaticity y1 and the set of the imaging angle θ2 and the chromaticity y2.

FIG. 20 shows an example of the reflection angle characteristics of chromaticity y.

In FIG. 20, the horizontal axis indicates the imaging angle (reflection angle) and the vertical axis indicates the chromaticity y, and the respective sets are plotted by black circles. Note that the chromaticity values are obtained by subtraction of y1 in the respective sets. Generally, reflection characteristics of a screen are symmetric with respect to the normal of the screen, and accordingly, the determination unit 182 regards the chromaticity y at the imaging angle −θ1 as y1 and the chromaticity y at the imaging angle −θ2 as y2, and plots these sets (in white).

Thus far, step S302 is explained.

Subsequently, the determination unit 182 determines the candidate closest to the reflection angle characteristics of brightness, the reflection angle characteristics of chromaticity x, and the reflection angle characteristics of chromaticity y of the candidates A, B, and C as the reflection characteristics of the screen 300 (step S303).

At step S303, the determination unit 182 operates in the following manner.

The determination unit 182 calculates the coincidence related value α with respect to each of the candidates A, B, and C.

Subsequently, the determination unit 182 plots the reflection angle characteristics of chromaticity x (see FIG. 19) in the respective candidates A, B, and C (see FIGS. 5 to 7).

Then, the determination unit 182 calculates a value of the square of the difference between the screen gain value in the candidate A and the chromaticity x in the reflection angle characteristics of chromaticity x with respect to each of the imaging angles −θ2, θ1, −θ1, θ2, and calculates the positive value of the square roots of the sums of the squares as a coincidence related value β according to the technique of calculating the coincidence related value α. The determination unit 182 also calculates the coincidence related values β with respect to each of the candidates B and C.

Subsequently, the determination unit 182 plots the reflection angle characteristics of chromaticity y (see FIG. 20) in the respective candidates A, B, and C (see FIGS. 5 to 7).

Then, the determination unit 182 calculates a value of the square of the difference between the screen gain value in the candidate A and the chromaticity y in the reflection angle characteristics of chromaticity y with respect to each of the imaging angles −θ2, θ1, −θ1, θ2, and calculates the positive value of the square roots of the sums of the squares as a coincidence related value γ according to the technique of calculating the coincidence related value β. The determination unit 182 also calculates the coincidence related values γ with respect to each of the candidates B and C.

Subsequently, the determination unit 182 calculates a coincidence related value Z by adding up the coincidence related value α, the coincidence related value β, and the coincidence related value γ with respect to each of the candidates A, B, and C.

Then, the determination unit 182 determines the candidate having the smallest coincidence related value Z of the candidates A, B, and C as the reflection characteristics of the screen 300.

Thus far, step S303 is explained. Subsequently, step S110 is executed.

According to modified example 1, the reflection characteristics of the screen 300 are determined based on the plurality of characteristics (brightness, chromaticity x, chromaticity y) relating to the reflection of the screen 300. Accordingly, compared to the case where the reflection characteristics of the screen 300 are determined based on the single characteristic, the determination accuracy of the reflection characteristics of the screen 300 can be made higher.

Note that the determination unit 182 may determine the candidate having the smallest coincidence related value of the candidates A, B, and C as the reflection characteristics of the screen 300, determine the candidate having the smallest coincidence related value γ as the reflection characteristics of the screen 300, or determine the candidate having the smallest sum of the coincidence related value β and the coincidence related value γ as the reflection characteristics of the screen 300.

### Modified Example 2

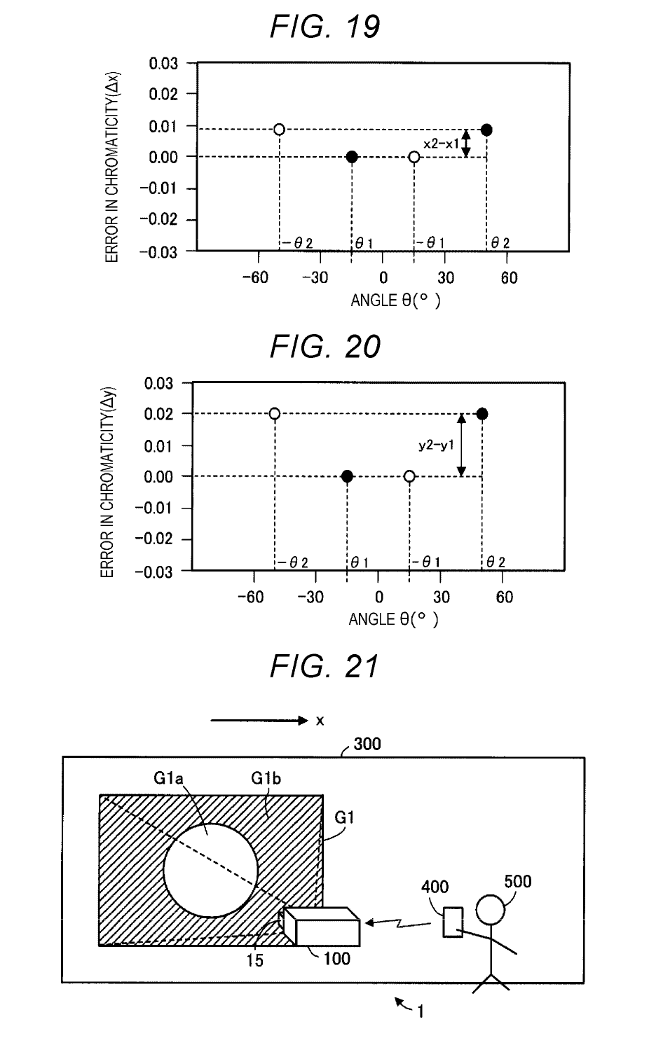

The communication unit 16 of the projector 100 may receive the second captured image information from a camera 400 operated by an observer 500 as shown in FIG. 21, not from the projector 200 forming the image projection system 1 with the projector 100. In this case, the projector 100 is not necessarily a projector forming the image projection system 1. Note that the camera 400 may be an apparatus with camera (e.g. smartphone).

### Modified Example 3

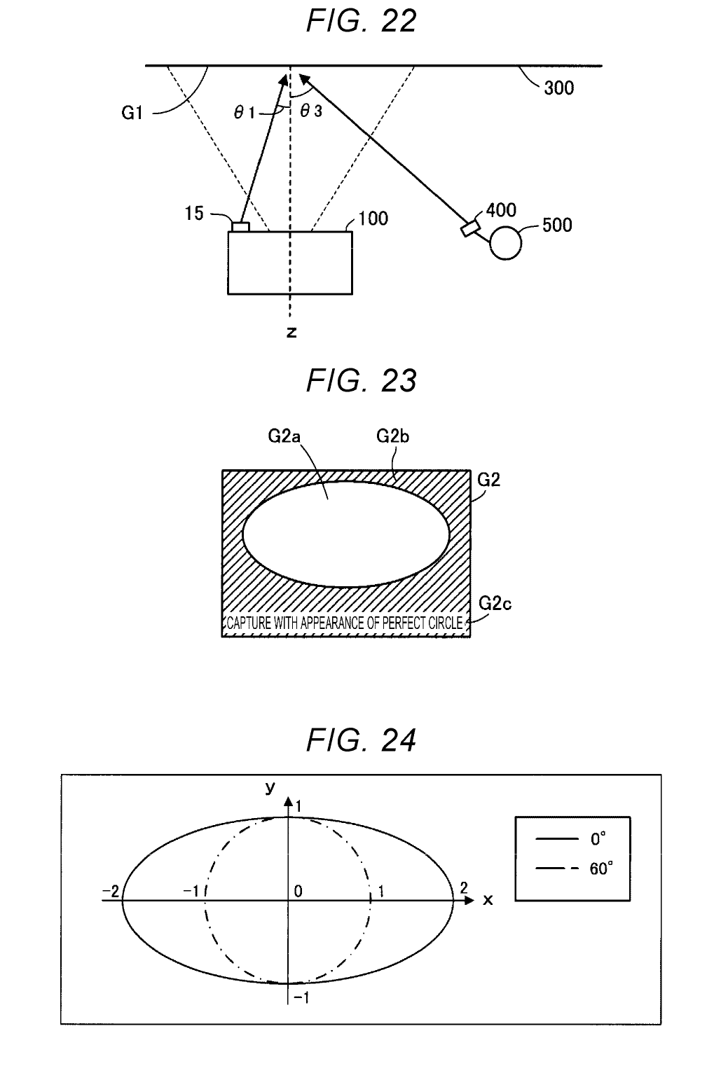

In the configuration shown in FIG. 21, the position of the camera 400 has less restriction than the position of the imaging unit 25 of the projector 200 shown in FIG. 1. Accordingly, for example, as shown in FIG. 22, the imaging angle of the camera 400 is easily set to an imaging angle θ3 considered to be effective for obtainment of the reflection characteristics of the screen 300.

Accordingly, in modified example 3, the projection unit 14 projects the image G1, and then, projects an image containing an angle detection pattern and a guide image prompting measurement of the angle detection pattern at the imaging angle θ3 (hereinafter, also simply referred to as “guide image”). Note that the imaging angle θ3 is another example of the second angle.

FIG. 23 shows an example of an image G2 containing a white angle detection pattern G2a, a guide image G2c, and a black background area G2b. FIG. 24 shows an example of the angle detection pattern G2a when the imaging angle θ3 is 60°. The angle detection pattern G2a shown in FIG. 24 is a perfect circle when the imaging angle θ3 is 60°.

Here, in an ellipse appearing as a perfect circle “^{x2}+y²=a” having a radius a from the position at an angle θ, letting the x-coordinate be Sa and the y-coordinate be Ta, Sa and Ta are obtained by the following expressions (5) and (6). Here, θ is 0° in the normal direction of the screen 300, +(positive) on the right side facing the screen 300, and −90°≤θ≤90°.

Sa=x/sin θ (5)

Ta=y (6)

When the angle detection pattern G2a shown in FIG. 24 is used, the observer 500 images the angle detection pattern G2a with the camera 400 from a position in which the angle detection pattern G2a appears as the perfect circle according to the guide image G2c. In this regard, the observer 500 specifies the position in which the angle detection pattern G2a appears as the perfect circle while watching the image shown in the camera 400. Note that, in the case where a measuring apparatus having no function of two-dimensional measurement (e.g. a colorimeter that can measure only a certain location or the like) is used in place of the camera 400, the observer 500 may visually check the shape of the angle detection pattern G2a and determine the imaging position.

The camera 400 images the angle detection pattern G2a and generates third captured image information. The third captured image information is another example of the second measurement result. Subsequently, the camera 400 transmits the third captured image information to the projector 100.

The communication unit 16 of the projector 100 receives the third captured image information. Specifically, the communication unit 16 receives the third captured image information after the projection of the image G2.

When the communication unit 16 receives the third captured image information, the specification unit 181 specifies the imaging angle θ3 using the x-coordinate of the angle detection pattern G2a represented by the third captured image information and the above described expression (5).

Here, the third captured image information is generated by imaging according to the guide image G2c and may be regarded as being generated by imaging at the imaging angle θ3. Accordingly, the specification unit 181 may specify the imaging angle θ3 without using the above described expression (5) or the like. However, in this case, the specification of the position in which the angle detection pattern G2a appears as a perfect circle depends on the observer, and the determination of the imaging angle θ3 may vary among different individuals. To solve the problem, the projector 100 may calculate the imaging angle θ3 based on the third captured image information, determine whether or not the calculated imaging angle θ3 is equal to the angle required by the projector 100 in real time, for example, and let the observer 500 know the determination result using a projected image or the like.

Then, the determination unit 182 creates the reflection angle characteristics of brightness, the reflection angle characteristics of chromaticity x, and the reflection angle characteristics of chromaticity y as described above using the first captured image information, the third captured image information, the imaging angle θ1, and the imaging angle θ3. Subsequently, the same operation as that of modified example 1 will be executed.

According to modified example 3, for example, the imaging angle θ3 may be indicated by the guide image G2c, and thereby, the third captured image information at the predetermined imaging angle θ3 can be used.

### Modified Example 4

In modified example 3, the projection unit 14 may sequentially project a plurality of images G2 at different imaging angles θ3 from one another, the observer 500 may image the angle detection pattern G2a with the camera 400 from the position in which the angle detection pattern G2a appears as the perfect circle according to the guide image G2c with respect to each image G2, and the camera 400 may transmit the third captured image information at each time of imaging to the projector 100.

In this case, the number of pieces of information for creation of the reflection angle characteristics of brightness, the reflection angle characteristics of chromaticity x, and the reflection angle characteristics of chromaticity y increases, and thereby, the accuracy of the reflection angle characteristics of brightness, the reflection angle characteristics of chromaticity x, and the reflection angle characteristics of chromaticity y can be made higher.

Further, in this case, the first captured image information can be omitted. Therefore, the imaging unit 15 may be omitted from the projector 100 and the configuration can be simplified. In this case, the communication unit 16 receives the second captured image information and the third captured image information, and the third captured image information is another example of the first measurement result.

### Modified Example 5

The determination unit 182 may determine the reflection characteristics of the screen 300 by execution of interpolation calculation based on the first captured image information and the second captured image information.

For example, the determination unit 182 first executes interpolation calculation based on the first captured image information and the second captured image information, and thereby, obtains brightness of the white area G1a corresponding to a position at an angle between the imaging angle θ1 and the imaging angle θ2.

Subsequently, the determination unit 182 determines the reflection characteristics of the screen 300 using the first captured image information, the second captured image information, and the brightness of the white area G1a corresponding to the position at the angle between the imaging angle θ1 and the imaging angle θ2.

As an example, the determination unit 182 analogizes at least one of values between the plotted points in FIG. 9, values between the plotted points in FIG. 19, and values between the plotted points in FIG. 20 by linear interpolation or least-squares method and determines the analogy result as the reflection characteristics of the screen 300.

In this case, to improve the accuracy, it is desirable that the number of plotted points is equal to or larger than three. Further, in this case, it is not necessary for the memory unit 17 to store the plurality of candidates (e.g. the candidates A to C).

### Modified Example 6

It is desirable that all of the imaging unit 15, the imaging unit 25, and the camera 400 have equal sensitivity. In the case where the imaging unit 15, the imaging unit 25, and the camera 400 differ in sensitivity from one another, it is desirable that the control unit 184 calibrates the captured image information using a sensitivity calibration coefficient that compensates for the differences in sensitivity.

### Modified Example 7

To measure brightness and chromaticity, other patterns than the angle detection patterns (e.g. the white area G1a and the angle detection pattern G2a) may be used. For example, as the patterns for measurement of brightness and chromaticity, a cross pattern and a white raster pattern are used. The cross pattern is used for alignment of coordinates of the center of the cross (the reference position of the projected image) and the pixel area 142a. The white raster pattern is used for measurement of brightness and chromaticity.

### Modified Example 8

In the case where a plurality of imaging units (imaging units 15 and 25) are provided in the projector 100, the projector 200 and the camera 400 may be omitted. In the case where a plurality of imaging units (imaging units 15 and 25) are provided in the projector 200, it is desirable that these imaging units are placed as far away as possible from each other and the difference between the imaging angles is larger.

### Modified Example 9

In addition to the projector 200, one or more projectors including imaging units may be connected to the projector 100 via wired or wireless connection. In this case, for example, the respective projectors capture the image G1 at different imaging angles from one another and generate captured image information. The projector 100 may receive the captured image information generated by the imaging units of the respective projectors, and generate at least one of the reflection angle characteristics of brightness, the reflection angle characteristics of chromaticity x, and the reflection angle characteristics of chromaticity y using these captured image information.

In this case, the number of pieces of information for creation of the reflection angle characteristics of brightness, the reflection angle characteristics of chromaticity x, and the reflection angle characteristics of chromaticity y increases, and thereby, the accuracy of the reflection angle characteristics of brightness, the reflection angle characteristics of chromaticity x, and the reflection angle characteristics of chromaticity y can be made higher.

### Modified Example 10

Generally, reflection characteristics of a screen are symmetric, and thus, in the above described embodiment etc., as the measurement values (brightness, chromaticity x, and chromaticity y) with respect to the imaging angle obtained by multiplication of the specified imaging angle by “−1”, the measurement values with respect to the specified imaging angle are used.

However, in the case of aiming to improve the determination accuracy of the reflection characteristics of the screen or in the case of using a screen of doubtful symmetry of the reflection characteristics of the screen, it is desirable that, as the measurement values with respect to the imaging angle obtained by multiplication of the specified imaging angle by “−1”, the measurement values with respect to the specified imaging angle are not used, but the captured image information at different imaging angles is increased and the measurement values are increased.

### Modified Example 11

The liquid crystal light valves 142 are used as light modulation devices, however, the light modulation devices are not limited to the liquid crystal light valves 142, but can be appropriately changed. For example, a configuration using three reflective liquid crystal panels as the light modulation devices may be employed. Further, the light modulation device may have a configuration using a single liquid crystal panel, three digital mirror devices (DMDs), or a single digital mirror device. In the case where only one liquid crystal panel or DMD is used as the light modulation device, the members corresponding to the color separation system and the light combining system are not necessary. Or, not only the liquid crystal panel or DMD but also a configuration that can modulate the light emitted by the light source 141 may be employed as the light modulation device.

### Modified Example 12

Part or all of the elements realized by the processing unit 18 reading and executing the programs may be realized by hardware using e.g. an electronic circuit such as an FPGA (field programmable gate array) or ASIC (Application Specific IC) or realized in cooperation of software and hardware.

Further, part or all of the elements realized by the image processing unit 11 reading and executing the programs may be realized by hardware using e.g. an electronic circuit such as an FPGA (field programmable gate array) or ASIC (Application Specific IC) or realized in cooperation of software and hardware.

What is claimed is:

1. A projector comprising:
a measurement unit that measures a feature quantity of a first image projected on a projection surface from a position at a first angle relative to the projection surface and generates a first measurement result;
a receiving unit that receives a second measurement result obtained by measurement of the feature quantity of the first image in a position at a second angle different from the first angle relative to the projection surface;
a determination unit that determines reflection characteristics of the projection surface based on the first measurement result and the second measurement result;
a correction unit that corrects first image information and generates second image information based on the reflection characteristics of the projection surface determined by the determination unit; and
a projection unit that projects a second image according to the second image information generated by the correction unit on the projection surface.

2. The projector according to claim 1, wherein the first measurement result shows a measurement result of measurement of a feature quantity of a measuring object portion contained in the first image from the position at the first angle,
the second measurement result shows a measurement result of measurement of a feature quantity of the measuring object portion contained in the first image from the position at the second angle, and
a position of the measuring object portion measured from the position at the first angle in the first image is the same as a position of the measuring object portion measured from the position at the second angle in the first image.

3. The projector according to claim 1, wherein the determination unit determines the reflection characteristics of the projection surface from a plurality of candidates of reflection characteristics based on the first measurement result and the second measurement result.

4. The projector according to claim 1, wherein the determination unit obtains a feature quantity of the first image corresponding to a position at an angle between the first angle and the second angle by executing interpolation calculation based on the first measurement result and the second measurement result, and determines the reflection characteristics of the projection surface using the first measurement result, the second measurement result, and the feature quantity of the first image corresponding to the position at the angle between the first angle and the second angle.

5. The projector according to claim 1, further comprising:
a memory unit that stores the reflection characteristics of the projection surface determined by the determination unit;
an operation unit that receives an operation by a user; and
a reading unit that reads the reflection characteristics of the projection surface from the memory unit when the operation unit receives an operation of reading the reflection characteristics of the projection surface.

6. The projector according to claim 1, wherein the measurement unit is an imaging unit that captures the first image projected on the projection surface from the position at the first angle and generates an imaging result as the first measurement result.

7. The projector according to claim 6, wherein the projection unit projects an image containing an angle detection pattern as the first image,
further comprising a specification unit that specifies the first angle based on an imaging result of the angle detection pattern by the imaging unit.

8. The projector according to claim 7, wherein the specification unit specifies the first angle based on a degree of deformation of the angle detection pattern shown in the imaging result.

9. The projector according to claim 7, wherein the projection unit projects an image containing the angle detection pattern and a guide image prompting measurement of the angle detection pattern at the second angle as the first image, and
the receiving unit receives the second measurement result after projection of the image containing the angle detection pattern and the guide image.

10. A projector comprising:
a receiving unit that receives a first measurement result obtained by measurement of a feature quantity of a first image projected on a projection surface from a position at a first angle relative to the projection surface and a second measurement result obtained by measurement of the feature quantity of the first image in a position at a second angle different from the first angle relative to the projection surface;
a determination unit that determines reflection characteristics of the projection surface based on the first measurement result and the second measurement result;
a correction unit that corrects first image information and generates second image information based on the reflection characteristics of the projection surface determined by the determination unit; and
a projection unit that projects a second image according to the second image information generated by the correction unit on the projection surface.

11. A method comprising:
measuring a feature quantity of a first image projected on a projection surface from a position at a first angle relative to the projection surface and generating a first measurement result;
receiving a second measurement result obtained by measurement of the feature quantity of the first image in a position at a second angle different from the first angle relative to the projection surface;
determining reflection characteristics of the projection surface based on the first measurement result and the second measurement result;
correcting first image information and generating second image information based on the reflection characteristics of the projection surface; and
projecting a second image according to the second image information on the projection surface.
